(19) United States
(12) Patent Application Publication
(10) Pub. No.: US 2009/0151708 A1
(43) Pub. Date: Jun. 18, 2009

(54) INTERNAL COMBUSTION ENGINE HAVING A SELECTIVELY INSULATED COMBUSTION CHAMBER

(76) Inventor: David J. Schouweiler, JR., Minneapolis, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 12/334,164

(22) Filed: Dec. 12, 2008

Related U.S. Application Data
(60) Provisional application No. 61/013,903, filed on Dec. 14, 2007.
(60) Provisional application No. 61/013,900, filed on Dec. 14, 2007.

(51) Int. Cl. F02B 75/08

(52) U.S. Cl. 123/668; 123/193.2

(57) ABSTRACT

An internal combustion engine cylinder assembly comprises a cylinder bore having a closed cylinder end and interior cylinder side walls. A piston slides in the cylinder between a bottom dead center (BDC) position and a top dead center (TDC) position and has a compression end facing the closed cylinder end. The piston and cylinder bore forming a combustion chamber between the piston, the interior cylinder side walls, and the closed cylinder end. The piston's compression end has a layer of a combustion-resistant thermal insulating material on. First and second valves at the closed cylinder end control flow of gasses into and from the cylinder volume between the piston and the closed end. A layer of a combustion-resistant insulating material forms the closed cylinder end of the cylinder bore, and extends part way toward the BDC piston position.

### CLAIM OF PRIOR APPLICATION FILING DATE

This is a regular application filed under 35 U.S.C. §111(a) claiming priority under 35 U.S.C. §119(e)(1), of provisional application Ser. No. 61/012,590, filed Dec. 10, 2007, and provisional application Ser. No. 61/013,903, filed Dec. 14, 2007 and provisional application Ser. No. 61/013,900 filed Dec. 14, 2007, all of which are incorporated herein by reference in their entirety.

### BACKGROUND OF THE INVENTION

Internal combustion engines based on the Otto cycle and Diesel cycle are commonly used in automobiles and trucks. Engines based on either of these designs have shortcomings in both fuel energy conversion efficiency and exhaust emissions cleanliness. There is an ongoing effort to improve these aspects. Improved engine designs are continually being built, tested, and brought to market. Improvements in fuel efficiency have been incremental, and are only slowly improving fuel mileage. Available emissions controls will clean the exhaust of pollutants, but these controls tend to be costly and bulky. The following discussion analyzes issues relating to engine efficiency improvement.

### Volumetric Efficiency

Engine designers know that increased pressure and temperature during combustion improves fuel efficiency. Designers of modern engines often aim to increase horsepower output per unit volume of cylinder displacement (i.e. increase volumetric efficiency), thereby permitting a smaller engine to provide power output similar to that of a larger engine along with improved fuel efficiency.

These small engines operate at a higher percentage of maximum power output than do larger engines. Operating in this manner requires higher combustion chamber pressure and temperature. This leads to greater energy efficiency than an equivalently powered large engine operating at lower combustion pressure and temperature. This however, is not so much an improvement in the thermal efficiency of an engine, as it is a more efficient match of an engine to a vehicle, to assure the engine operates at a more thermally efficient level during operation.

### Cooling Losses

Otto cycle and Diesel cycle engines both require a cooling system to quickly remove heat from combustion chamber metals that each combustion event generates, since the average combustion gas temperature during a 4-stroke engine cycle is much higher than that at which the chamber materials can reliably operate. Heat energy conducted through the combustion chamber metal into the cooling system represents a significant drop in thermal efficiency.

Ceramic engines, also called adiabatic engines, were popularly prototyped in the 1980s, see SAE Technical Papers 810070 (1981), 820431 (1982), 840428 (1984), and 840434 (1984), whose abstracts are currently viewable at http:www.sae.org/technical/papers, and where they may be downloaded. These engines attempted to harness this lost coolant energy by selectively or completely insulating the combustion chamber, thus eliminating the need for circulating coolant. Unfortunately, the prototype engines may have retained too many conventional engine design features. Use of ceramics for insulation of combustion chambers in adiabatic engines is not currently favored.

### BRIEF DESCRIPTION OF THE INVENTION

An internal combustion engine cylinder assembly comprises a cylinder bore having a closed cylinder end and interior cylinder side walls. A piston slides in the cylinder between a bottom dead center (BDC) position and a top dead center (TDC) position and has a compression end facing the closed cylinder end. The piston and cylinder bore forming a combustion chamber with the piston, the interior cylinder side walls, and the closed cylinder end. First and second valves at the closed cylinder end control flow of gasses into and from the cylinder volume between the piston and the closed end.

The piston's compression end has on it, a layer of a combustion-resistant thermal insulating material. A layer of a combustion-resistant insulating material forms the closed cylinder end of the cylinder bore, and extends part way toward the BDC piston position. The valve surfaces within the combustion chamber have a layer of combustion-resistant insulating material.

### BRIEF DESCRIPTION OF THE DRAWINGS

FIG. 1 is a section view of an internal combustion engine's cylinder assembly incorporating the invention.

FIG. 2 is an exploded perspective view of a piston incorporating the invention.

### DESCRIPTION OF THE PREFERRED EMBODIMENTS

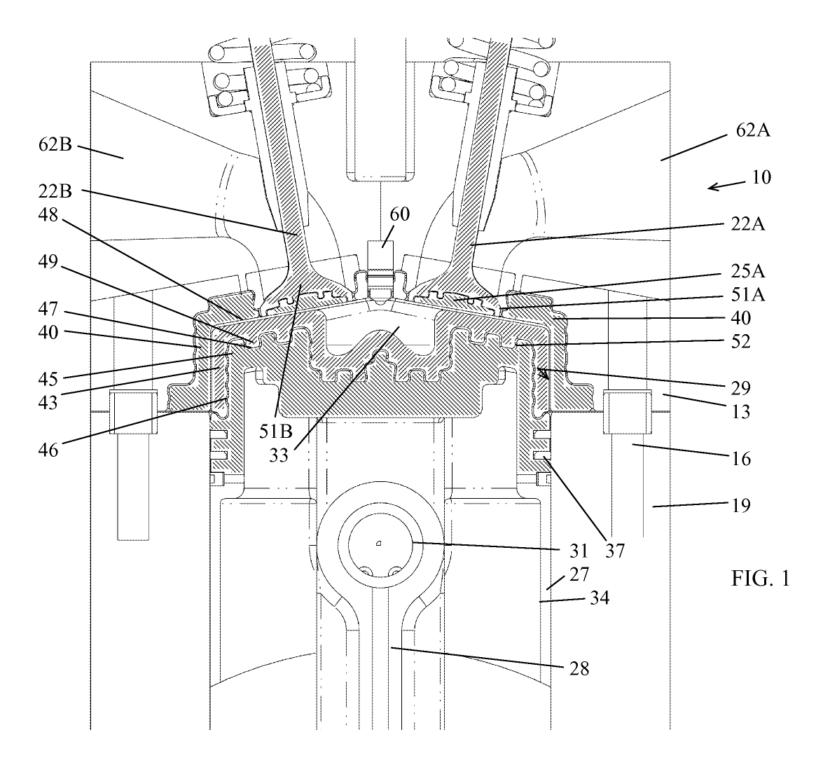

FIG. 1 shows the features of an internal combustion engine cylinder assembly 10 incorporating the invention. Typically, an engine for a vehicle will have four, five, six, or eight cylinder assemblies 10 cooperatively driving a single crankshaft.

Assembly 10 in many ways is identical to a single cylinder in a conventional engine. Assembly 10 includes a block 19 and a head 13 held together with symbolically shown head bolts 16. Block 19 and head 13 have bores cooperatively forming a cylinder bore 27 in which a piston 34 slides from a top dead center (TDC) position shown in FIG. 1 to a bottom dead center (BDC) position with piston 34 entirely within block 19 and in fact well below head 13. Piston 34 has conventional rings 37 that seal against the sidewalls of bore 27 to prevent gas leakage from bore 27. Rings 37 slide only against the portion of bore 27 within block 19.

A closed cylinder end 48 defines the very top of bore 27. A compression end 47 of piston 34 along with cylinder end 48 and the sides of bore 27 define a combustion chamber 33 extending along the cylinder bore 27 walls to rings 37. Of course, the volume of the combustion chamber depends on the position of piston 34 within bore 27.

Valves 22A and 22B control flow of gasses into and from the combustion chamber. Seat surfaces on the stem sides of valves 22A and 22B mate with seats forming a part of ducts 62A and 62B to control flow of gasses between combustion chamber 33 and ducts 62A and 62B.

If valve 22A functions as the intake valve, air, and possibly fuel as well, flow into the combustion chamber through intake duct 62A in head 13 when valve 22A is open. If valve 22A is the intake valve, then valve 22B will function as the exhaust valve. When valve 22B is open, combustion gasses flow from the combustion chamber into an exhaust duct 62B in head 13. Of course, the pressure within duct 62A must be lower than the pressure in the combustion chamber to cause such flow.

Piston 34 connects in a conventional way to a crankshaft (not shown) with a connecting rod 28. Connecting rod 28 pivots on a wrist pin 31 carried by piston 34.

The purpose of this invention is to increase efficiency of an engine by reducing the amount of wasted heat and supporting more complete fuel combustion. The invention provides these advantages by at least partially surrounding the combustion chamber 33 with thermal insulating material until combustion is complete, and the gasses have undergone a substantial increase in the temperature and pressure within combustion chamber 33. The increased pressure causes piston 34 to slide downwards, adding a substantial portion of uninsulated bore 27 walls to the combustion chamber 33.

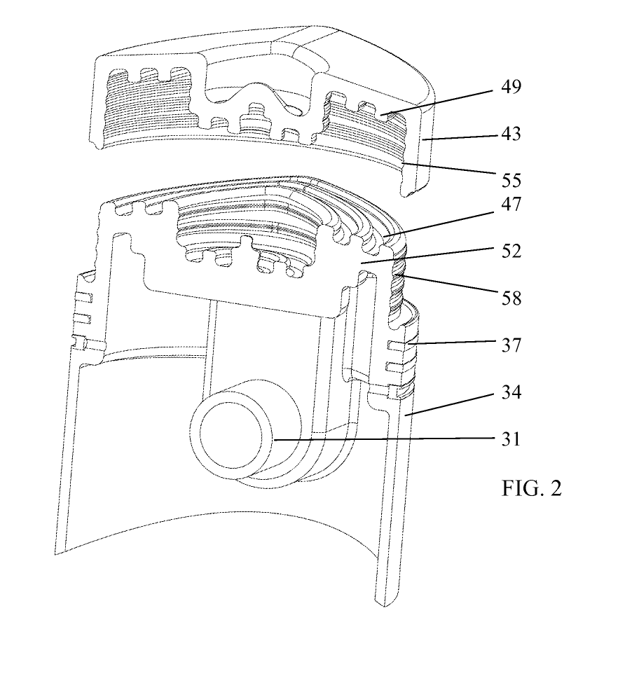

To provide this feature, ceramic thermal insulating material forms a portion of the surfaces defining the combustion chamber 33. FIG. 2 shows the construction of a piston having a layer of a combustion-resistant thermal insulating material on the piston 34 compression end 47. A cap 43 forms this layer.

In this context, “combustion-resistant” for a material means that the material is inert over perhaps as many as 10⁹ individual combustion events (power strokes), which corresponds to thousands of hours of engine operation, and can resist overpressures in the range of 500-20,000 psi. without deteriorating. “Thermal insulating” means the material has a thermal conductivity in the range of approximately 0.5-20.0 W./m./° C.

One material that may satisfy these criteria is partially stabilized zirconia (PSZ), see SAE Technical Papers 820429 (1982) and 830318 (1983), whose abstracts are currently viewable at http://www.sae.org/technical/papers, where downloads of them are also available. These papers discuss vehicular uses for PSZ. PSZ thermal conductivity is approximately 2.0 W./m./° C. Further experimentation with other materials having somewhat higher thermal conductivity, may lead to reduced ablation over many combustion cycles.

In FIG. 2, cap 43 has an outside diameter slightly smaller than the inside diameter of bore 47, see FIG. 1. Cap 43 has a minimum inside diameter that is slightly larger than a head portion 45 of piston 34. Thus, cap 43 can slip over head portion 45 into the position shown in FIG. 1. In this way, cap 43 insulates the surface of the combustion chamber 33 that piston 34 forms.

Cap 43 is directly exposed to hot combustion gasses, requiring cap 43 to comprise a combustion-resistant thermal insulating material. Thermal insulating materials fulfilling this requirement have good compressive strength but typically have little tensile strength and are quite brittle. To reduce thermal expansion stress on cap 43 and the other ceramic components, the metal to which these ceramic components are attached preferably have similar coefficients of thermal expansion.

Cast iron is one preferred material from which to make piston 34 and head 13 when the ceramic components are made from PSZ, since PSZ has a coefficient of thermal expansion that is sufficiently close to that of cast iron. For this reason, a piston 34 made from cast iron will limit thermal expansion for a PSZ cap 43, reducing tensile stress on cap 43. Aluminum may be an alternate piston 34 and head 13 material, if the combustion-resistant thermally insulating material is compatible with the greater thermal expansion coefficient of aluminum.

Cast iron is a good choice for pistons for another reason. The carbon particles in cast iron provide substantial lubricity for a piston 34 made from it, reducing internal friction between piston 34 and bore 27.

A potential problem with a composite structure such as piston 34 is a means for firmly attaching cap 43 to piston head portion 45. To attach cap 43, the interior side walls of cap 43 preferably have concentric cross sectional undulations 55. The exterior sidewalls of head portion 45 also have concentric cross sectional undulations 58. The cross section of undulations 58 is complementary to the cross section of undulations 55. “Complementary” in the context of undulations 55 and 58 means that projecting portions of one surface align with recessed portions of the other but do not project into the recesses.

In the case of undulations 55 and 58, the minimum inside diameter of cap 43 is slightly larger than the maximum outside diameter of portion 45 to allow cap 43 to slip over head portion 45, and create between them a clearance space 46.

Cap 43 also has concentric projections 49 at the bottom thereof that mate in a complementary manner with grooves 47 at the end of piston 34, in this context “complementary” meaning that projections 49 actually project into the adjoining grooves 47. These projections 49 and grooves 47 also create additional clearance spaces 52 between them usable to firmly attach cap 43 to the head portion 45 of piston 34.

Since projections 49 do project into grooves 47, the bottom of each groove 47 is slightly wider than the mouth thereof. The maximum (radial) width of each projection 49 is slightly less than the radial width of the mouth of the groove 47 into which that projection 49 fits.

Both cast iron and PSZ (and other combustion-resistant thermal insulating materials) do not bond well, or at all, to many types of bonding materials. To firmly attach cap 43 to head portion 45, an attaching or retention material that is preferably liquid during assembly and then solidifies, fills clearance spaces 46 and 52.

During assembly, the liquid retention material fills the clearance spaces 46 and 52, say by immersing cap 43 and head portion 45. After slipping cap 43 onto head portion 45, the retention material solidifies to firmly attach cap 43 to head portion 45. The undulations and geometry of the clearance space 46 and 52 cause the attaching material to strongly resist any forces arising during use of assembly 10 that might loosen cap 43 on or remove cap 43 from head portion 45.

It is likely that many types of materials are suitable for use as the retention material for attaching cap 43 to portion 45. Some that may function properly for this purpose are zinc, aluminum, their alloys, and other low temperature metals. Pure zinc melts at 420° C., pure aluminum at 660° C., both of which are far lower than the temperature at which cast iron melts, which is 1540° C. A zinc or aluminum alloy that melts at from 500-800° C. may be most suitable for use as an attaching material. Because of the thermal insulating properties of PSZ and similar insulating ceramics, the temperature of the attaching material, whatever is used, remains in the neighborhood of 200-300 deg. C. during operation of an engine using assembly 10.

Affixing cap 43 to piston 34 requires a carefully timed immersion of these components into a bath of molten zinc. The zinc bath is kept well above its melting point to provide sufficient energy to quickly heat the iron and ceramic surfaces beyond the melting temperature of zinc. Piston 34 and cap 43 are masked to selectively heat the surfaces to be joined, and the submersion process is timed to assure the component surfaces rise just beyond the melting temperature of the bath while the cores remain sufficiently cool to rapidly solidify the zinc once the components are precisely positioned together.

The retention material must have a low melting point, in order to solidify and lock piston 34 and cap 43 together while at similar thermally expanded dimensions. Whatever zinc alloy is selected as the retention material should retain tensile strength at full-throttle engine operating temperatures. Even though the zinc retention material is unable to bond to either the cast iron or the ceramic, it locks cap 43 onto piston 34 by solidifying between the components. In one embodiment, clearance spaces 46 and 52 may be on the order of 0.5 mm. thick.

A conventional adhesive may alternately form the retention material, but the result is not certain, so the focus here is on a low melting temperature metal as the retention material. For example, an epoxy might harden sufficiently to retain a ceramic component, but could deteriorate when exposed to the thermal and mechanical shocks over time.

In fact, the alignment may not need to be complementary as described above, but may be any physical arrangement of the facing surfaces providing mechanical interlocking between the components when retaining material is present.

Valves 22A and 22B respectively have flanges 51A and 51B with seat surfaces on the stem sides of flanges 51A and 51B that mate with seats forming the periphery of ducts 62A and 62B. Two planchets 25 made of combustion-resistant thermal insulating material form the surfaces of flanges 51A and 51B facing the interior of combustion chamber 33. Concentric grooves and projections on flanges 51A and 51B mate complementarily with concentric grooves and projections on planchets 25 to retain planchets 25 on flanges 51A and 51B.

Because at least exhaust valve flange 51B heats to a relatively high temperature from flow of exhaust gasses into duct 62B, the retention material for attaching planchet 25 to flange 51A ideally melts at a relatively high temperature, say 600-900° C. Aluminum or an aluminum alloy likely forms a better retention material for planchet 25 to resist the higher temperatures involved.

The higher tensile loads for valves 22A and 22B make other materials more preferable for them than cast iron. Certain stainless steels having a coefficient of thermal expansion similar to that of the material forming planchets 25 likely will be successful materials from which to form valves 22A and 22B.

Since valves 22A and 22B may be subject to severe physical loading and distortion, planchets 25 may not possess the required longevity in some engine applications. Alternatively, a ceramic film or other combustion-resistant film coating on the order of 0.5 mm. thick may be applied to the valves 22A and 22B faces. Such a film coating will function effectively, though at a somewhat reduced thermal efficiency compared to a ceramic planchet 25.

Lower cost embodiments may eliminate insulation from portions of combustion chamber 33. For example, omitting insulation for valves 22A and 22B results in only a slight loss in thermal efficiency. This embodiment is functional, as the valves will absorb heat energy during combustion, and will conduct this heat away through thermally conductive valve seats that transfer this heat into the head 13. In addition, other low cost embodiments may eliminate certain segments of insulation, with additional loss in thermal efficiency. Other embodiments may substitute a ceramic film or other combustion-resistant film in place of the cap 43 and/or cover 40.

A cover 40 made from a combustion-resistant thermal insulating material forms the end and side wall 29 of bore 27 within head 13. A small clearance between wall 29 and cap 43 prevents rubbing and friction between them. Cover 40 forms the portion of bore 27 within head 13 unoccupied by valve flanges 51A and 51B. If cover 40 comprises brittle ceramic material, it should fit closely within a cavity in the head 13 to limit tensile loads on the cover 40 material.

The result of this structure is that so long as piston 34 is within head 13, the combustion chamber 33 is almost completely thermally insulated by combustion-resistant thermally insulating material. The heat generated from fuel combustion within combustion chamber 33 early in the power stroke is almost entirely dedicated to expanding the combustion gasses, increasing efficiency of transforming combustion energy into mechanical energy.

As piston 34 shifts toward BDC during a power stroke, more and more of bore 27 within head 13 becomes part of the bore 27 defining combustion chamber 33. However, combustion chamber 33 remains almost fully insulated until cap 43 completely exits cover 40 during a power stroke while piston 34 moves toward the BDC position. A small amount of hot gasses may flow into the clearance space between cap 43 and the adjacent bore 27 within block 19 before cap 43 leaves cover 40. Since this clearance space is essentially a “dead end” because only a very small amount of combustion gasses can pass through the seal between piston rings 37 and the adjacent walls of bore 27, little heat transfers from the combustion gasses to the side walls of bore 27 until piston 34 completely exits cover 40.

Once piston 43 is completely within block 19, then heat from the combustion gasses can begin to transfer to the side walls of bore 27. If future research suggests that insulation on combustion chamber 33 having this configuration does not optimize efficiency, the configuration can change to provide insulation for whatever percentage is appropriate. For example, the height of cover 40 as measured in FIGS. 1 and 2 can change to provide the appropriate size of insulated combustion chamber 33. Likely the insulated volume of combustion chamber 33 should be from 10-50% of the maximum combustion chamber 33 volume at BDC, with 25% perhaps ideal.

### Exhaust Losses

Otto cycle and Diesel cycle engines both require a muffler to quiet the explosive exhaust energy escaping the cylinder when the exhaust valve is open. The audible exhaust energy is one indicator of the tremendous level of heat energy lost in the exhaust.

Both the Miller cycle and the Atkinson cycle engines available in certain high mileage vehicles today attempt to harness some of this lost exhaust energy. Specifically, these engines both use an extended expansion cycle to extract more work from combustion pressure before allowing it to escape to the exhaust. The result is a slightly cooler and slightly quieter exhaust, with more combustion energy transferred to the crankshaft.

### Exhaust Emissions

Computer management and emissions controls allow modern engines to expel exhaust into the atmosphere that is remarkably free of NOx, HC, CO, and carbon soot emissions. The emissions controls necessary to accomplish this task are costly, bulky, and often reduce thermal efficiency.

There are well established methods to reduce each of these four types of emissions. However, these methods are not always compatible with current engine designs. Specifically, reduction of NOx emissions is achieved by limiting the temperature and duration of the hottest portion of the combustion process, but this is not particularly practical in smaller engines which run at higher horsepower levels than before.

Reduction in HC is achieved through reduction in intake/exhaust valve timing overlap, which allows traces of inducted fuel to flow directly out the exhaust without ever going through a combustion cycle, but this is difficult to achieve in higher performance engines. Reduction in CO emissions is achieved through a fuel-lean combustion process, but is not necessarily desirable in a modern spark ignition environment at high volumetric efficiencies. Soot emissions are prevented with a homogenous intake fuel/air charge, but this is not yet possible with the stratified intake charge of a Diesel cycle engine.

Solutions to scrub each of these four pollutants from the exhaust flow of modern engines exist, but all may be undesirable due to cost, reduced thermal efficiency, and bulk.

Using this design for a partially insulated cylinder assembly 10, a number of innovative and advantageous ways to implement engine operation exist. Cylinder assembly 10 can operate at compression ratios of 20:1 or greater, allowing use of a Diesel cycle with fuel injection from injector 60. Alternatively, injector 60 can be omitted, and a premixed fuel-air mixture drawn into combustion chamber 33 through valve 22A. Then the extreme compression causes combustion of the fuel-air mixture in the form of a detonation. Using lower compression ratios will require spark ignition. The following discussion examines some of the considerations and mechanisms that can profitably use this cylinder assembly 10 design in the form of an insulated pulse engine (IPE).

The duration of a combustion event in a typical internal combustion engine relative to the crankshaft speed imposes a fundamental limitation on fuel energy conversion efficiency. Completing combustion when the piston is at or just past top dead center (TDC) improves fuel efficiency. Combustion at this time allows the gasses to expand to many times their volume at combustion and cool with remarkable efficiency.

The conflict with this ideal in modern engines is the goal of generating high levels of horsepower in a small displacement, as this requires that the cylinder pressure remain high for much of the expansion stroke. Conventional designs keep pressure high later into the expansion stroke by continually combusting more fuel as the combustion chamber enlarges.

Otto cycle engine designs burn fuel over much of the expansion stroke. Diesel cycle engine designs inject fuel during a substantial portion of the expansion stroke. Fuel that burns later in the expansion cycle will not expand as much before the exhaust stroke as does fuel that burns early in the cycle. The result is significant pressure and heat energy in the exhaust because of this later burning fuel.

To optimize efficiency, fuel must ignite, combust, and burn out rapidly near TDC. The drawback to this rapid burn is reduced horsepower output per cubic inch of cylinder displacement, since the combustion reaction must be small to prevent excessive cylinder pressure damage.

The following discussion examines some of the considerations and mechanisms that can profitably use this cylinder assembly 10 design in the novel concept of an Insulated Pulse Engine (IPE):

The Insulated Pulse Engine (IPE) is a reciprocating piston internal combustion engine which utilizes a selectively insulated combustion chamber, a constant volume intake cycle, a rapid fuel-lean combustion process, and an unconventionally high expansion ratio, to achieve improved fuel energy conversion efficiency at comparatively low volumetric efficiency when compared to conventional engines of similar displacement. The resulting Insulated Pulse Engine has greatly reduced cooling requirements and does not need a muffler to run quietly. The IPE expels a comparatively cool, pressureless exhaust, and cannot benefit from any form of supercharging. The IPE may use compression ignition in one embodiment and spark ignition in another embodiment.

The IPE benefits from complete combustion near TDC (top dead center), requiring the combustion chamber be designed using established methods which promote rapid combustion. In Otto and Diesel cycle engines, combustion is designed to extend well into the expansion cycle. This generates high levels of power, but the late burning fuel cannot expand as many times as the early burning fuel, resulting in large amounts of energy lost to the exhaust in the form of heat and pressure. The late burning gasses also promote heat energy loss into thermally conductive cylinder walls.

Because the “peak” pressure of gasses in an IPE are constrained by the same physical limitations as peak pressure in conventional engines, the “average” pressure of gasses in the brief-burning IPE is necessarily lower than that found in an Otto or Diesel engine, therefore the horsepower output for a given displacement IPE is notably less than that of a conventional engine. An IPE of equal horsepower will require greater cylinder displacement than a conventional engine. The greater cylinder block size of the IPE is somewhat compensated by reduction in space required for cooling, muffling, and emissions control. Unlike published adiabatic engines of the 1980s, the relaxed ceramic components of the IPE will not notably fatigue, and will not define the lifespan of the engine.

The IPE has a fuel energy conversion efficiency of roughly 65%. Fuel energy is extracted as follows: 10% is conducted as combustion heat out the oil cooler, 10% is convected as heat energy out the exhaust, 15% is lost to mechanical friction as heat out the oil cooler, 0% is lost to pumping air through the engine, and 65% exits the crankshaft as useable mechanical energy.

Since a fast burn speed (near simultaneous burn or alternately a flame front faster than 1000 m/s) is a desirable feature for an IPE, and since the specific technology selected to generate the quick combustion speeds is not significant, the IPE can readily function as a rapid combusting variant of the Otto cycle engine or the Diesel cycle engine.

A Diesel cycle embodiment of the IPE described next integrates IPE concepts with the cylinder assembly 10 structure. An HCCI cycle embodiment of the IPE then briefly describes the additional benefit of intrinsically low exhaust emissions of this embodiment. Lastly, the Otto cycle embodiment of the IPE provides practical, high thermal efficiency, low exhaust emissions, low cost operation.

### Insulated Diesel Cycle

In the Diesel cycle embodiment, valve timing is such that only 50% of cylinder volume is utilized for compression, and the full cylinder volume is utilized for expansion. If the engine has a 100 mm bore and 100 mm stroke, the compression cycle occupies only the final 50 mm of stroke before TDC. The expansion cycle occupies the entire 100 mm stroke after TDC. The 20:1 compression ratio needed for spontaneous combustion of direct injected fuel provides a 40:1 expansion ratio. This unusually large expansion ratio extracts virtually all useable heat and pressure in the cylinder before the exhaust valve opens, resulting in a cool, quiet exhaust cycle with minimal flow requirements, eliminating any potential for use of a turbocharger to reclaim exhaust energy.

The intake cycle effectively draws fresh air during the first 50 mm of stroke after TDC. Intake valve 22A closes at 090° ATC to reduce “air pump” energy losses through the ports. Piston 34 pulls a vacuum for the last half of the intake stroke as the piston moves toward BDC. The resulting vacuum at BDC draws the piston back toward TDC, efficiently recovering the kinetic energy lost when generating the vacuum, and minimizing the air flow requirements of the intake cycle.

Executing a 40:1 expansion ratio with a 100 mm stroke mandates the combustion chamber 33 volume at TDC be closely regulated to avoid mechanical collision between the piston 34 and cover 40. Matching and balancing the thermal expansion coefficient of all core engine components, and designing the engine to circulate cooling oil in a manner which assures all components remain at similar operating temperatures solves many of these potential problems.

The Diesel cycle IPE operates as a 4-stroke engine. In one embodiment this engine has the following stages:

1) Intake

2) Vacuum

3) Rebound

4) Compression

5) Ignition

6) Combustion

7) Expansion

8) Vacuum

9) Rebound

10) Exhaust.

The following list describes one possible operating embodiment for an engine incorporating these stages. The list starts at TDC.
005 ATC: Intake valve 22A opens, drawing in fresh air as a Diesel does.
090 ATC: Intake valve 22A closes as piston 34 falls at 50% of stroke distance from TDC.
095 ATC: Piston continues downward, combustion chamber 33 is at a vacuum compared to atmospheric (1.0 ATM).
180 BDC: Combustion chamber pressure falls to 1.0 ATM×0.50^{1.4}=0.38 ATM.
175 BTC: Piston 34 elastically rebounds off vacuum, being pulled upward.
090 BTC: Vacuum rebound ends, compression of fresh air begins.
055 BTC: Cylinder wall within block 19 no longer forms part of combustion chamber 33, and combustion chamber 33 becomes insulated.
050 BTC: Compression adiabatically heats air within combustion chamber 33.
008 BTC: Fuel injector 60 directly injects fuel into (insulated) combustion chamber 33.
005 BTC: Violent, spontaneous, fuel-lean combustion begins.
000 TDC: Fuel injection ends.
005 ATC: Piston pressure is at maximum.
010 ATC: 90% of fuel has combusted and combustion effectively ends.
015 ATC: Combustion is over, but combustion gasses quality improves.
020 ATC: Temperatures remain hot and unquenched in combustion chamber 33.
050 ATC: Temperatures within combustion chamber 33 adiabatically plummet as mechanical energy transfers to crankshaft.
055 ATC: Uninsulated cylinder wall gets first exposure to rapidly cooling combusted gas.
120 ATC: Cylinder starts pulling a vacuum (low throttle).
150 ATC: Cylinder starts pulling a vacuum (mid throttle).
180 BDC: Vacuum peaks (low/mid throttle). Exhaust valve opens (full throttle).
175 BTC: Piston 34 elastically rebounds off the vacuum (low/mid throttle).
150 BTC: Cylinder vacuum ends, exhaust valve opens (mid throttle).
120 BTC: Cylinder vacuum ends, exhaust valve opens (low throttle).
005 BTC: Exhaust valve closes (EVC).

Low throttle conditions generate a unique valve timing condition in the IPE, as a 40:1 expansion cycle becomes excessive without the presence of sufficient fuel to generate pressure the full expansion distance. Since “low throttle” expansion pulls a vacuum before reaching 180 BDC, and since the exhaust valve conventionally opens at 180 BDC, the piston will be kinetically decelerated by the vacuum during the expansion stroke, but the “vacuum rebound” energy will be lost to the exhaust port if the valve opens at BDC, thus requiring more fuel be injected to sustain low throttle activity. This suggests conventional engine exhaust valve timing is effective at full-throttle levels in the IPE, but wastes fuel energy at lesser throttle positions in the IPE.

The solution at low throttle position is to dynamically vary the timing of the exhaust valve opening (EVO) without varying the timing of exhaust valve closure. The IPE uses two exhaust camshafts which are coordinated to achieve this goal. One exhaust camshaft would be timed to always close the exhaust valve near 005 BTC. A second exhaust camshaft with dynamically variable timing would define when the exhaust valve opens. While the exhaust valve would be timed to open 180 BDC at full throttle, low throttle would require the exhaust valve open as late as 120 BTC, thus pulling a vacuum for much of the expansion stroke and recovering as much of this lost kinetic energy as possible during the rebound stroke. “Rebound” starts at 180 BDC and lasts until the vacuum disappears, at which time the exhaust valve opens. This low-throttle algorithm minimizes air pumping energy loss through the exhaust ports.

The dynamic compression ratio (DCR) is 20:1 in the described IPE. At 20:1, in an insulated environment with minimal heat soak, compressed cylinder pressure will reach 20^{1.4}=66 ATM prior to ignition at TDC. Direct injected fuel readily combusts in this insulated environment without need for a glow plug. Full throttle combustion pressure limits defined to be 120 ATM in the tiny combustion chamber just after TDC are controlled by direct fuel injection constrained to lean limits.

Intake valve timing might generally benefit from continuous regulation, to assure the compression ratio is always optimized for rapid combustion as conditions vary, and through all crankshaft RPMs, assuming port flow limitations affect the volume of inducted air as RPMs change. To provide maximum combustion versatility, IVO and EVC can be controlled with a fix timed camshaft, IVC can be controlled by a separate servo-controlled dynamically timed camshaft to assure proper air volumes are induced to achieve ignition under all engine conditions, and EVO can be controlled by another servo-controlled dynamically timed camshaft to assure the exhaust performs efficiently at all throttle positions.

Cold weather starts introduce a potential design issue with the insulating ceramic components affixed to the piston or cylinder head. The issue of “thermal shock” may occur during very cold starts where the ceramic heats before the piston or head warms, resulting in accelerated thermal expansion of ceramic components while the piston and head remain cold and unexpanded. Stresses may build, either within the ceramic component, or between the ceramic component and the piston or head which are sufficient to shear ceramic interlocking features off, resulting in failure of the engine. Engine and component design must pay attention to thermal shock, to assure tensile forces do not approach the stress limits of the ceramic during warm up. It is likely that cold winter starts will require processor management to assure power output is limited in the first minutes after start-up. Controlled oil circulation will permit accelerated heating of critical engine components, allowing the piston and head to optimally warm when the engine is started cold.

The following table compares a Diesel cycle IPE at full-throttle to a conventional 4-stroke Otto cycle 1.6 liter engine selected as a baseline reference point:
100HP: Power from conventional 1.6 liter spark-ignition engine.
060HP: When limited to 3600 RPM due to ceramic inertial load limitations.
030HP: Using only 50% of stroke for compression cycle.
010HP: Fuel-lean condition to limit cylinder pressure and ceramic fatigue.
018HP: 90% of combustion occurs within 10 degrees of TDC.
023HP: Partially insulating combustion chamber retains pressure energy.
025HP: Compression ratio increased from 10:1 to 20:1.
030HP: Expansion stroke is 2× longer than compression stroke.
025HP: Increased friction losses partly offset by reduced air flow losses.
100HP: IPE engine is given four times the displacement of conventional engine.
End with an equivalently powered 6.4 liter IPE with twice the fuel efficiency.

100HP is what an Otto cycle 6.4 liter IPE might generate. This may seem a small power output for such a large displacement engine, but the fuel mileage in a 100 horsepower IPE powered vehicle is twice that of a 100 horsepower conventional Otto cycle engine, and a 6.4 liter IPE power train would occupy roughly the same vehicle space as a 1.6 liter conventional engine power train. Additionally, the 6.4 liter IPE's 100 horsepower output is considered a “continuous” power rating available for sustained periods, not just a “peak” power rating available for limited durations. Since an IPE-based engine might weigh somewhat more than an equivalent smaller displacement conventional engine, some slight reduced efficiency may result from this added engine weight.

The premise of only doubling mechanical friction losses in a 6.4 liter IPE generating 100 horsepower, when compared to a 1.6 liter conventional engine generating 100 horsepower, is based on the notion that a free-spinning, unloaded engine generates far less bearing, piston skirt, and ring tension friction than the same engine when heavily loaded. It is assumed that, horsepower to horsepower, the IPE will generate only twice the friction of a conventional engine, even though the larger diameter piston travels a longer distance, since it runs at lower average loads than in the conventional engine.

The IPE described to this point must combust a fuel-lean mixture to assure the rapid combustion reaction, which completes near 010 ATC and does not build cylinder pressure which exceeds the limits of the relatively small combustion chamber 33 formed by the brittle ceramic cover 40 and cap 43. A cylinder misfire may allow leftover condensed fuel in the cylinder to combust in the next cylinder firing, resulting in a potentially stoichiometric mix that is more powerful than the tiny combustion chamber will reliably survive.

Integrating a spring-loaded relief valve into the cylinder head 13 to release excess pressure to the exhaust port 62B at cylinder pressure limits may protect the engine in this situation.

The described Diesel cycle IPE suffers from ordinary soot emissions, since fuel (diesel, gasoline, alcohol, etc) must be gradually injected into a Diesel combustion chamber over time and spontaneously combusted in an environment which may or may not contain sufficient local oxygen to assure complete combustion. The chamber becomes oxygen-starved near the focus of combustion, allowing excess fuel within this region to partially combust in the form of soot, which stabilizes to become a stubborn pollutant. Modern direct injectors fight to reduce soot emissions by increasing injection pressures and improving atomization, but some soot remains. Lean-burn fuel injected environments greatly reduce soot formation, and may be sufficient to keep emissions low. Emissions control methods are commercially available to convert soot into carbon dioxide, but they are expensive and consume energy. The combination of low volumetric efficiency and possible soot emissions expenses may or may not prevent commercial interest in the high fuel efficiency Diesel cycle IPE engine.

A Diesel engine combusts fuel at the rate it is injected. This rate is fine for creating lots of power but is too slow for optimal energy conversion efficiency. Speeding the rate of injection increases soot, while slowing the rate of injection reduces energy conversion efficiency. Addition of turbulence to the Diesel's combustion cycle speeds combustion and reduces pollutants, but a high level of turbulence is not readily achieved during injection in modern Diesels. These two issues (rate of combustion and soot) can be sidestepped by eliminating direct fuel injection and premixing the lean fuel/air mix in the intake port prior to induction, as this assures fuel is never combusted in a low oxygen environment. The result is an HCCI cycle IPE engine with exhaust emissions far lower than a Diesel cycle IPE.

### Insulated HCCI Cycle

The flame front in a conventional Otto cycle engine propagates at a controlled rate of up to 100 meters per second from the spark plug. Undesirable pre-ignition knock in a conventional Otto cycle engine may propagate at greater than 1000 m/s. The IPE prefers the latter speed, or even faster, for optimal efficiency. The combinations of pre-mixed fuel/air, compression ignition, insulated chamber, and fuel-lean induction, all contribute to a near instantaneous combustion environment sought by the IPE for maximum energy conversion efficiency. This combustion rate is significantly faster than pre-ignition knock, but knock is prevented in the HCCI cycle IPE due to restricted fuel volume preventing excessive pressure. Combustion basically initiates and completes in all portions of the HCCI cycle IPE combustion chamber at the same time. Since the HCCI must spontaneously combust prior to TDC, and since it combusts nearly instantaneously, it is unable to utilize the full compression ratio of the engine as efficiently as a Diesel cycle IPE. Complete combustion prior to TDC also generates momentary pressure on the bearings, piston skirt, and piston rings, which generate a momentary mechanical friction loss before TDC which is not present in the Diesel cycle IPE. The homogenous fuel/air charge of the HCCI cycle IPE eliminates soot emissions, the lean fuel-air mix eliminates CO emissions, and the instantaneous combustion in a controlled pressure environment eliminates NOx emissions, making the HCCI cycle IPE an engine which requires no emissions controls. The HCCI cycle IPE offers promise, but the general science of HCCI engines must advance to commercial levels before the IPE variation may become practical.

### Insulated Otto Cycle

An Otto cycle engine is another variation of the IPE. It retains the HCCI cycle IPE exhaust emissions benefits, and deviates from the modern Otto cycle engine in that it requires an unconventionally fuel-lean induction charge and inducts this homogenous fuel/air charge at constant volume, much as an HCCI engine inducts a fuel/air charge.

The Otto cycle IPE operates with sufficient induction air volume to pre-warm the lean fuel-air charge during compression to just below the spontaneous compression temperature when TDC is reached, readily promoting ignition when a spark is generated at TDC.

The Otto cycle IPE can generate slightly more power per unit displacement, since combustion chamber volume at TDC is slightly larger then the Diesel cycle and HCCI cycle IPEs. The Otto cycle IPE retains the variable compression and expansion ratios of the Diesel cycle IPE and HCCI cycle IPE, using a camshaft servo to regulate the compression pressure to bring the lean premixed fuel-air to just below spontaneous ignition threshold, allowing minimal spark energy at TDC to generate a near instantaneous ignition throughout the homogenous mix, resulting in high thermal efficiency and very low emissions. Since the required lean fuel/air mix is difficult to ignite with a spark, a comparatively high compression ratio is required to assure the spark energy will trigger a combustion event. This necessarily high compression ratio makes the Otto cycle IPE a thermally efficient variation of the conventional Otto cycle engine, albeit with lower volumetric efficiency.

Note that using a multi-spark algorithm which initially provides a low energy spark followed microseconds later by a series of increasing spark energies may allow continuous optimization of the compression ratio in the Otto cycle IPE. By basing the spark timing on the volatility of the fuel-air mixture, and allowing real-time compression ratio corrections may further improve thermal efficiency. The Otto cycle IPE may be sufficiently simple and fuel efficient to find commercial interest.

What I claim is:

1. An internal combustion engine cylinder assembly comprising:
a) a cylinder bore having a closed cylinder end and interior cylinder side walls;
b) a piston sliding in the cylinder between a bottom dead center (BDC) position and a top dead center (TDC) position and having a compression end facing the closed cylinder end, said piston and cylinder bore forming a combustion chamber between the piston, the interior cylinder side walls, and the closed cylinder end;
c) a layer of a combustion-resistant thermal insulating material on the piston's compression end;
d) first and second valves at the closed cylinder end and controlling flow of gasses into and from the cylinder volume between the piston and the closed end; and
e) a layer of a combustion-resistant insulating material forming the closed cylinder end of the cylinder bore, and extending part way toward the BDC piston position.

2. The assembly of claim 1, wherein the valves each include a wall surface facing the interior of the cylinder, wherein the valves' wall surfaces comprise a combustion resistant insulating material;

3. The assembly of claim 2, wherein the piston's combustion-resistant thermal insulating material layer comprises a cap formed of ceramic fitting over the piston's compression end, and the piston comprises a material with a coefficient of thermal expansion similar to the cap material.

4. The assembly of claim 3, wherein the cap comprises partially-stabilized zirconia.

5. The assembly of claim 3, wherein the cap has an interior wall having inside diameter and the piston's compression end has an exterior wall thereat having an outside diameter greater than the cap's inside diameter, thereby creating a first clearance space between the cap and the piston, and a retaining material within the first clearance space.

6. The assembly of claim 5, wherein the retaining material comprises zinc.

7. The assembly of claim 5 wherein the cap's interior wall has an undulating cross section, and wherein the piston's exterior wall has a cross sectional configuration complementary to the cross section of the cap's interior wall.

8. The assembly of claim 6, wherein the thermal insulating material covers substantially the entire exterior of the cylinder's closed end unoccupied by the valves.

9. The assembly of claim 1, wherein a valve includes a flange end with a seating surface for seating against a valve seat in the cylinder end, and a combustion chamber surface facing away from the seating surface, wherein the combustion chamber surface includes at least one projection, and further including a planchet formed of a combustion-resistant thermal insulating material, with a cavity conforming to the projection on the valve's combustion chamber surface with a second clearance space therebetween, and a retaining material occupying the second clearance space.

10. The assembly of claim 1, wherein the piston's combustion-resistant thermal insulating material layer comprises a cap formed of ceramic fitting over the piston's compression end, and the piston comprises a material with a coefficient of thermal expansion similar to the cap material.

11. The assembly of claim 10, wherein the cap and a piston surface within the cap each have concentric features complementary to each other.

12. The assembly of claim 10, wherein bores in a head and a block cooperate to form the cylinder bore, and including in the head, a cover forming the closed cylinder end.

13. The assembly of claim 12, wherein the cover fits closely within a cavity in the head.

14. The assembly of claim 1, wherein the cap comprises partially-stabilized zirconia.
